(19) United States
(12) Patent Application Publication
(10) Pub. No.: US 2026/0143282 A1
(43) Pub. Date: May 21, 2026

(54) AUDIO SYSTEM

(71) Applicant: ALPS ALPINE CO., LTD., Tokyo (JP)

(72) Inventors: Hiroyuki TAGUCHI, Fukushima (JP); Ryo ITO, Fukushima (JP); Yuji SAITO, Fukushima (JP)

(21) Appl. No.: 19/360,302

(22) Filed: Oct. 16, 2025

(30) Foreign Application Priority Data
Nov. 19, 2024 (JP) 2024-201379

(51) Int. Cl. H04R 3/12; H04S 3/00

(52) U.S. Cl. CPC H04R 3/12; H04S 3/008; H04R 2430/01; H04R 2499/13; H04S 2420/07

(57) ABSTRACT

An audio system includes first and second seat speakers respectively arranged near first and second seats of an automobile, which respectively output first and second audio signals; a microphone arranged in the first seat; and a circuitry configured to perform gain adjustment on the second audio signal; extract, as a crosstalk signal, a component of output sound of the second seat speaker included in output of the microphone; extract, as a noise signal, a component of the output of the microphone that does not include components of output sounds of the first and second seat speakers; and calculate a gain adjustment amount of the second audio signal in the gain adjustment so that the crosstalk signal becomes lower than the noise signal by a predetermined level. The circuitry uses the calculated gain adjustment amount to perform the gain adjustment on the second audio signal.

### CROSS-REFERENCE TO RELATED APPLICATIONS

The present application is based on and claims priority to Japanese Patent Application No. 2024-201379, filed on Nov. 19, 2024, the entire contents of which are incorporated herein by reference.

### BACKGROUND OF THE INVENTION

### 1. Field of the Invention

The present invention relates to an audio system.

### 2. Description of the Related Art

As a technique for controlling a sound field so that a sound to be heard, which is a sound to be heard by a user, can be heard only by the user, there is known a technique for outputting a sound to be heard from a speaker to a first area where the user is located, and outputting a pseudo noise which inhibits hearing of the sound to be heard from a speaker to a second area which is an area where hearing of the sound to be heard is to be prevented, such as an area where another person is located (see, for example, Patent Document 1).

### RELATED-ART DOCUMENTS

### Patent Documents

Patent Document 1: Japanese Unexamined Patent Application Publication No. 2019-83408

When a user in the driver's seat and a user in the passenger's seat listen to different music in an automobile, it is desirable that one user hears the music listened by the user yet does not hear the music listened by the other user.

Therefore, it is conceivable to output a pseudo noise for masking the music listened by the other user, for one user.

However, because the pseudo noise is a noise that does not exist naturally, the noise environment in which the one user listens to music is degraded.

### SUMMARY OF THE INVENTION

It is an object of the present invention to output music to each user in such a manner that one user does not hear the music listened by the other user without degrading the noise environment of music listening by one user.

According to an embodiment, an audio system includes a first seat speaker configured to be arranged near a first seat of an automobile; a microphone configured to be arranged at a position near a head of a user seated in the first seat; a second seat speaker configured to be arranged near a second seat of the automobile; a first seat sound source configured to output a first audio signal to be output from the first seat speaker; a second seat sound source configured to output a second audio signal; and circuitry configured to perform gain adjustment on the second audio signal that is output to the second seat speaker; extract, as a crosstalk signal, a component of output sound of the second seat speaker included in output of the microphone; extract, as a noise signal, a component of the output of the microphone that does not include a component of output sound of the first seat speaker and the component of the output sound of the second seat speaker; and calculate a gain adjustment amount of the second audio signal in the gain adjustment so that the crosstalk signal becomes lower than the noise signal by a predetermined level, wherein the circuitry is configured to use the calculated gain adjustment amount to perform the gain adjustment on the second audio signal, and to output the second audio signal to the second seat speaker.

### BRIEF DESCRIPTION OF THE DRAWINGS

Other objects and further features of the present invention will be apparent from the following detailed description when read in conjunction with the accompanying drawings, in which:

FIG. 1 is a diagram illustrating a configuration of an audio system according to an embodiment of the present invention;

FIG. 2 is a diagram illustrating an arrangement example of a microphone and a speaker according to an embodiment of the present invention;

FIG. 3 is a diagram illustrating a configuration of a crosstalk detection unit according to an embodiment of the present invention;

FIG. 4 is a diagram illustrating a configuration of a noise detection unit according to an embodiment of the present invention; and

FIG. 5 is a diagram illustrating a configuration of a gain calculation unit and a per-band gain adjustment unit according to an embodiment of the present invention.

### DESCRIPTION OF THE EMBODIMENTS

In an audio system according to an embodiment of the present invention, while adjusting the gain of a second audio signal for a second seat to a level at which the user of a first seat does not hear the signal, the adjustment amount can be reduced to a level at which the user of the first seat does not hear the second audio signal due to noise, so that the listening of the second audio signal by the user of the second seat is not disturbed as much as possible.

According to an embodiment of the present invention, it is possible to output music to each user in such a manner that the one user does not hear the music being listened by the other user without degrading the noise environment of the music listening by the one user.

Hereinafter, an embodiment of the present invention will be described.

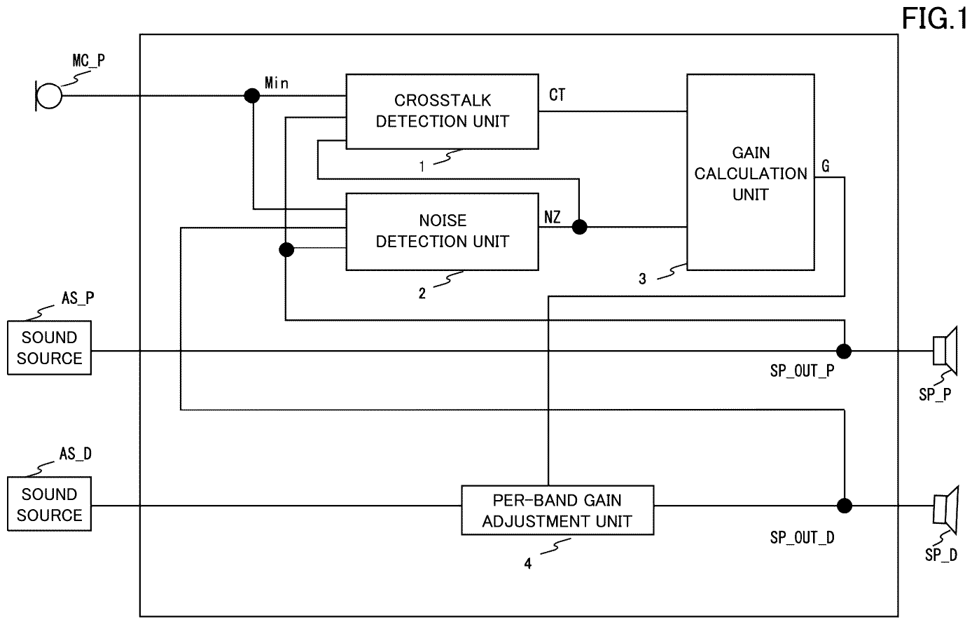

FIG. 1 illustrates a configuration of an audio system according to the present embodiment.

This audio system is a system to be mounted on an automobile, and as illustrated in FIG. 1, the audio system includes a microphone MC_P for the front passenger seat, a speaker SP_P for the front passenger seat, and a speaker SP_D for the driver seat.

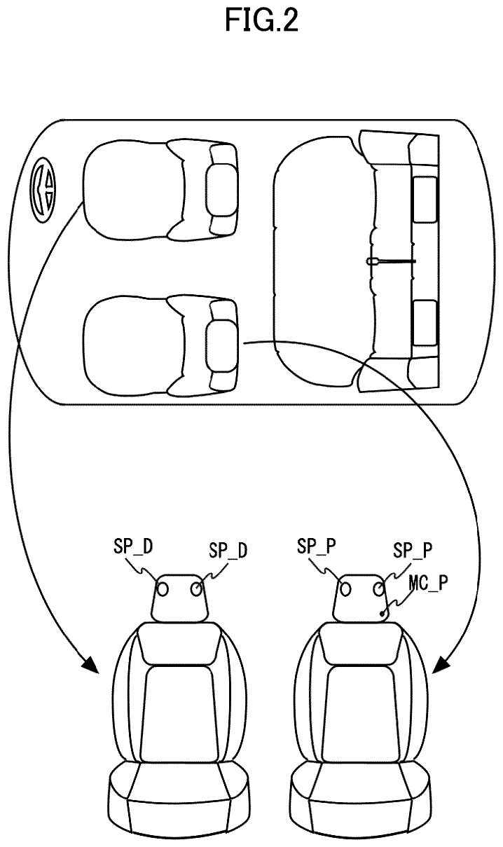

Here, as illustrated in FIG. 2, the microphone MC_P for the front passenger seat and the speaker SP_P for the front passenger seat are arranged at a position near the head of the user seated in the front passenger seat, such as the headrest of the front passenger seat, and the speaker SP_D for the driver seat is arranged at a position near the head of the user seated in the driver seat, such as the headrest of the driver seat.

Referring back to FIG. 1, the audio system includes a sound source AS_P for the front passenger seat and a sound source AS_D for the driver seat, and the audio signal of the sound source AS_P for the front passenger seat is output from the speaker SP_P for the front passenger seat, and the audio signal of the sound source AS_D for the driver seat is output from the speaker SP_D for the driver seat.

In the present embodiment, the output to the speaker SP_D for the driver seat is adjusted so that the user seated in the front passenger seat does not hear the audio signal of the sound source AS_D for the driver seat.

The audio system includes a crosstalk detection unit 1, a noise detection unit 2, a gain calculation unit 3, and a per-band gain adjustment unit 4. The crosstalk detection unit 1, the noise detection unit 2, the gain calculation unit 3, and the per-band gain adjustment unit 4 are an electronic circuit (including processor) such as a CPU, a GPU, a DSP, an FPGA, and an ASIC, which executes various processing described in the present disclosure by executing instruction codes stored in a memory or by designing a circuit for a special application.

The per-band gain adjustment unit 4 is what is referred to as an equalizer and adjusts the gain of the audio signal of the sound source AS_D for the driver's seat according to a gain control signal G output by the gain calculation unit 3 for each ⅓ octave band and outputs the audio signal to the speaker SP_D for the driver's seat.

The crosstalk detection unit 1 extracts, as a crosstalk signal CT, a component of the output SP_OUT_D of the speaker SP_D in the microphone input signal Min, with the output of the microphone MC_P for the passenger's seat being a microphone input signal Min and the output of the speaker SP_D for the driver's seat being SP_OUT_D.

The noise detection unit 2 extracts, as a noise signal NZ, a component of the microphone input signal Min excluding a component of the output SP_OUT_D of the speaker SP_D and a component of the output SP_OUT_P of the speaker SP_P, with the output of the speaker SP_P for the passenger's seat being SP_OUT_P.

Here, the noise signal NZ includes, as a main component, a component of environmental noise that the audio system does not engage in, such as road noise.

The gain calculation unit 3 calculates a gain of the per-band gain adjustment unit 4 for attenuating the audio signal of the sound source AS_D for the driver's seat by an excess amount of the level of the crosstalk signal CT with respect to the level of the noise signal NZ, for each ⅓ octave band, and outputs a gain control signal G for controlling the gain of the per-band gain adjustment unit 4 to the calculated gain.

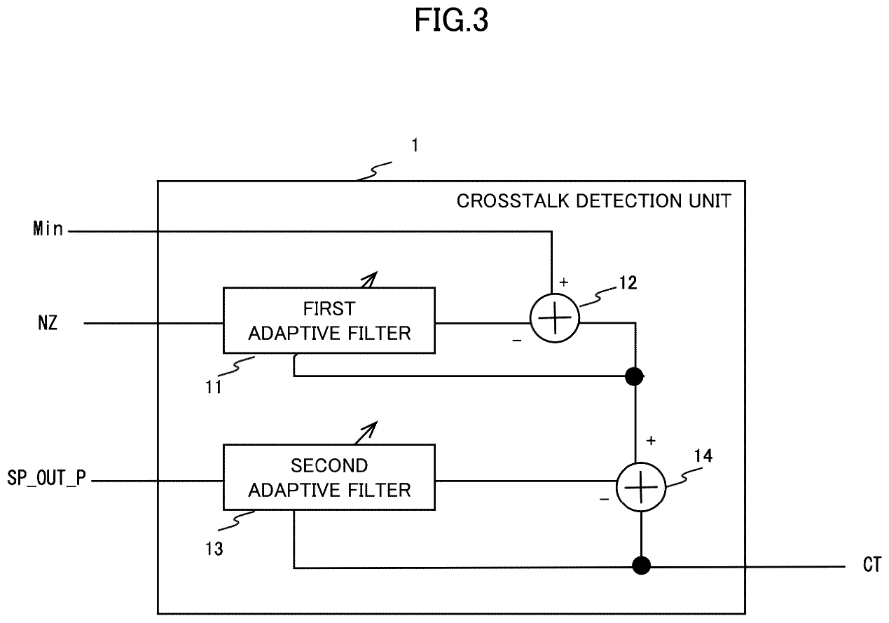

Next, a configuration of the crosstalk detection unit 1 is illustrated in FIG. 3.

As illustrated, the crosstalk detection unit 1 includes a first adaptive filter 11, a first adder 12, a second adaptive filter 13, and a second adder 14.

The first adaptive filter 11 is an adaptive filter having the noise signal NZ as an input, and the first adder 12 subtracts the output of the first adaptive filter 11 from the microphone input signal Min and outputs the signal.

The first adaptive filter 11 sets its own transfer function (filter coefficient) so that the output of the first adder 12 becomes minimum.

Therefore, the output of the first adder 12 is a signal obtained by removing the component of the noise signal NZ from the microphone input signal Min.

Next, the second adaptive filter 13 is an adaptive filter whose input is the output SP_OUT_P of the speaker SP_P for the front passenger seat, and the second adder 14 subtracts the output of the second adaptive filter 13 from the output of the first adder 12 and outputs it.

The second adaptive filter 13 sets its own transfer function (filter coefficient) so that the output of the second adder 14 is minimized.

Therefore, the output of the second adder 14 is a signal obtained by removing the component of the noise signal NZ and the component of the output signal SP_OUT_P (the output component of the speaker SP_P for the front passenger seat) from the microphone input signal Min, that is, a signal representing the wraparound component (crosstalk) of the output of the speaker SP_D for the driver's seat in the microphone input signal Min, and this signal is output as the crosstalk signal CT.

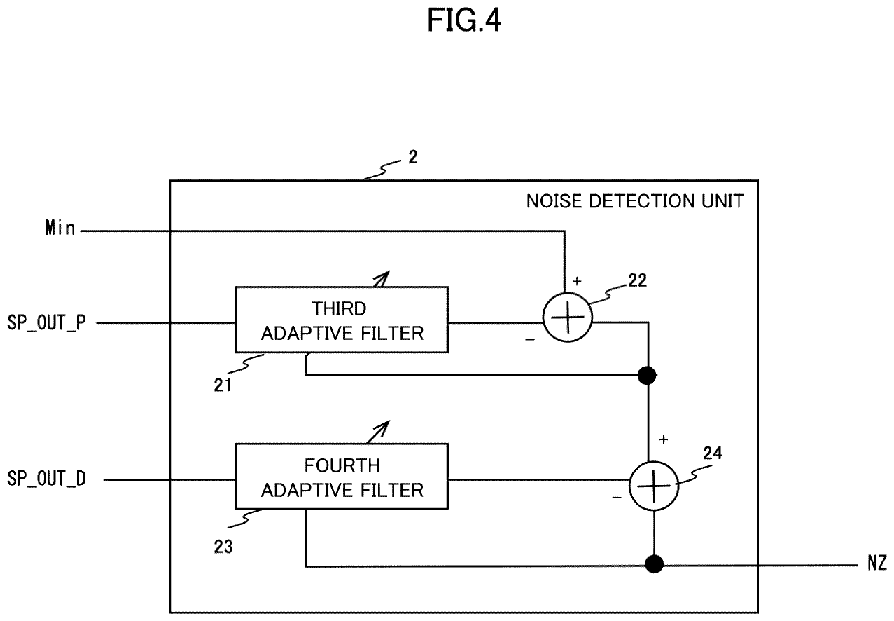

Next, the configuration of the noise detection unit 2 is illustrated in FIG. 4.

As illustrated, the noise detection unit 2 includes a third adaptive filter 21, a third adder 22, a fourth adaptive filter 23, and a fourth adder 24.

The third adaptive filter 21 is an adaptive filter having the output SP_OUT_P of the speaker SP_P for the front passenger seat as an input, and the third adder 22 subtracts the output of the third adaptive filter 21 from the microphone input signal Min and outputs it.

The third adaptive filter 21 sets its own transfer function (filter coefficient) so that the output of the third adder 22 is minimized.

Therefore, the output of the third adder 22 is a signal obtained by removing the component of the output SP_OUT_P of the speaker SP_P for the front passenger seat from the microphone input signal Min.

Next, the fourth adaptive filter 23 is an adaptive filter having the output SP_OUT_D of the driver's seat speaker SP_D as an input, and the fourth adder 24 subtracts the output of the fourth adaptive filter 23 from the output of the third adder 22 and outputs the subtracted output.

The fourth adaptive filter 23 sets its own transfer function (filter coefficient) so that the output of the fourth adder 24 is minimized.

Therefore, the output of the fourth adder 24 is a signal obtained by removing, from the microphone input signal Min, the component of the output signal SP_OUT_P (the output component of the passenger's seat speaker SP_P) and the wraparound component (crosstalk) of the output of the driver's seat speaker SP_D, i.e., a signal representing the noise component in the microphone input signal Min, and this signal is output as a noise signal NZ.

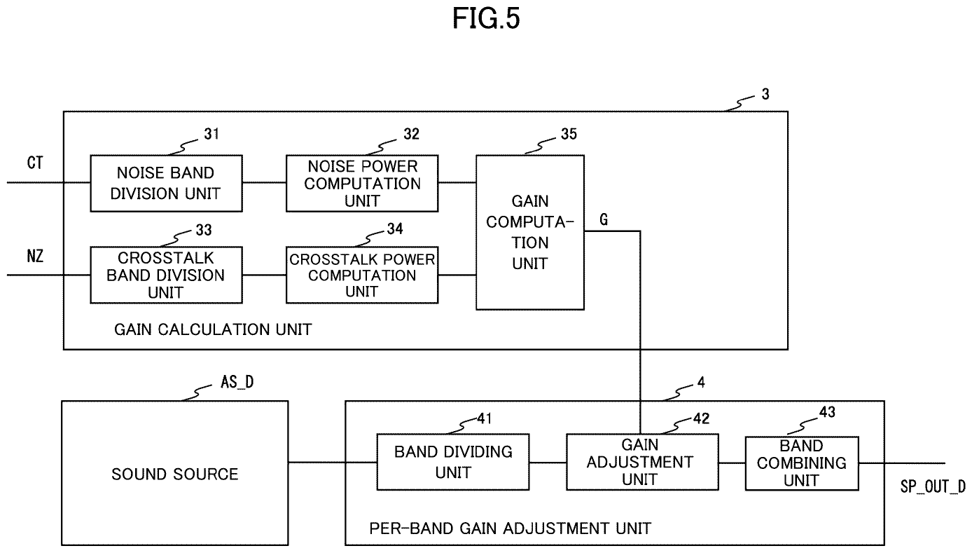

Next, FIG. 5 illustrates the configuration of the gain calculation unit 3 and the per-band gain adjustment unit 4.

As illustrated, the gain calculation unit 3 includes a noise band division unit 31, a noise power computation unit 32, a crosstalk band division unit 33, a crosstalk power computation unit 34, and a gain computation unit 35.

The noise band division unit 31 divides the noise signal NZ for each ⅓ octave band, and the noise power computation unit 32 calculates the power of the divided noise signal NZ for each band.

The crosstalk band division unit 33 divides the crosstalk signal CT for each ⅓ octave band, and the crosstalk power computation unit 34 calculates the power of the divided crosstalk signal CT for each band.

The gain computation unit 35 calculates the gain of the per-band gain adjustment unit 4, for each band, so that the audio signal SP_OUT_D after gain adjustment output by the per-band gain adjustment unit 4 is attenuated by an amount obtained by adding a margin to the excess of the power of the noise signal NZ with respect to the power of the crosstalk signal CT, that is, so that the power of the crosstalk signal CT is lower than the power of the noise signal NZ by a predetermined level, and outputs it to the per-band gain adjustment unit 4 as a gain control signal G. More specifically, for example, the gain computation unit 35 calculates the gain of the per-band gain adjustment unit 4, for each band, so that the audio signal SP_OUT_D after gain adjustment output by the per-band gain adjustment unit 4 is attenuated by an excess amount of the power of the noise signal NZ with respect to the power of the crosstalk signal CT, that is, so that the power of the crosstalk signal CT is less than or equal to the power of the noise signal NZ, and outputs it to the per-band gain adjustment unit 4 as a gain control signal G.

The gain computation unit 35 calculates a gain of an attenuation amount of 0 for a band where the power of the crosstalk signal CT is lower than the power of the noise signal NZ.

A plurality of sets of gains for each band may be prepared in advance, and a set having a minimum attenuation amount in which the power of the crosstalk signal CT is lower than the power of the noise signal NZ in all bands may be selected and used as a gain control signal G.

A lower limit may be provided for each band for the gain calculated by the gain computation unit 35.

Next, the per-band gain adjustment unit 4 includes a band dividing unit 41, a gain adjustment unit 42, and a band combining unit 44.

The band dividing unit 41 divides the audio signal of the sound source AS_D for the driver's seat into ⅓-octave frequency bands, the gain adjustment unit 42 adjusts the gain of the audio signal for each divided band according to the gain control signal G input from the gain calculation unit 3, and the band combining unit 44 combines the audio signal of each band after the adjustment and outputs it to the speaker SP_D for the driver's seat.

The embodiments of the present invention have been described above.

As described above, according to the present embodiment, while adjusting the gain of the audio signal output for the driver's seat to a level not heard by the user of the front passenger seat, the adjustment amount can be reduced to a level not heard by the user of the front passenger seat due to noise, so that listening of the audio signal for the driver's seat by the user of the driver's seat is not disturbed as much as possible.

Although the above description describes the case where the output to the speaker SP_D for the driver's seat is adjusted to a level at which the audio signal of the sound source AS_D for the driver's seat is not heard by the user sitting in the passenger's seat, the audio system may be provided with the above configuration and a configuration that is symmetrical to with respect to the passenger's seat and the driver's seat, and the output to the speaker SP_P for the passenger's seat may be adjusted to a level at which the audio signal of the sound source AS_P for the passenger's seat is not heard by the user sitting in the driver's seat.

The driver's seat and the front passenger's seat in the above embodiments may be replaced by any two seats of an automobile.

What is claimed is:

1. An audio system comprising:
a first seat speaker configured to be arranged near a first seat of an automobile;
a microphone configured to be arranged at a position near a head of a user seated in the first seat;
a second seat speaker configured to be arranged near a second seat of the automobile;
a first seat sound source configured to output a first audio signal to be output from the first seat speaker;
a second seat sound source configured to output a second audio signal; and
circuitry configured to
perform gain adjustment on the second audio signal that is output to the second seat speaker;
extract, as a crosstalk signal, a component of output sound of the second seat speaker included in output of the microphone;
extract, as a noise signal, a component of the output of the microphone that does not include a component of output sound of the first seat speaker and the component of the output sound of the second seat speaker; and
calculate a gain adjustment amount of the second audio signal in the gain adjustment so that the crosstalk signal becomes lower than the noise signal by a predetermined level, wherein
the circuitry is configured to use the calculated gain adjustment amount to perform the gain adjustment on the second audio signal, and to output the second audio signal to the second seat speaker.

2. The audio system according to claim 1, wherein the circuitry generates the crosstalk signal by removing, from the output of the microphone, a component of the noise signal and the component of the output sound of the first seat speaker.

3. The audio system according to claim 1, wherein the circuitry generates the noise signal by removing, from the output of the microphone, the component of the output sound of the first seat speaker and the component of the output sound of the second seat speaker.

4. The audio system according to claim 1, wherein
the circuitry generates the crosstalk signal by removing, from the output of the microphone, a component of the noise signal and the component of the output sound of the first seat speaker, and
the circuitry generates the noise signal by removing, from the output of the microphone, the component of the output sound of the first seat speaker and the component of the output sound of the second seat speaker.

5. The audio system according to claim 1, wherein
the circuitry calculates, for each of predetermined bands, a gain adjustment amount of the second audio signal in the gain adjustment so that the crosstalk signal becomes lower than the noise signal by a predetermined level, and
the circuitry adjusts, for each of the predetermined bands, the gain of the second audio signal by the gain adjustment amount calculated for a corresponding band of the predetermined bands.

6. The audio system according to claim 1, wherein one seat of the first seat and the second seat is a driver's seat and another seat of the first seat and the second seat is a passenger's seat.
